(19) United States
(12) Patent Application Publication
(10) Pub. No.: US 2007/0178249 A1
(43) Pub. Date: Aug. 2, 2007

(54) METHODS OF FORMING METAL LAYERS USING METAL-ORGANIC CHEMICAL VAPOR DEPOSITION

(75) Inventors: Min-Woo Song, Gyeonggi-do (KR); Seok-Jun Won, Seoul (KR); Dae-Jin Kwon, Gyeonggi-do (KR); Weon-Hong Kim, Gyeonggi-do (KR); Ju-Youn Kim, Gyeonggi-do (KR); Jung-Min Park, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/623,815

(22) Filed: Jan. 17, 2007

(30) Foreign Application Priority Data
Feb. 1, 2006 (KR) 2006-09787

(51) Int. Cl. H05H 1/24

(52) U.S. Cl. 427/569

(57) ABSTRACT

Provided is a method of forming a metal layer using metal-organic chemical vapor deposition (MOCVD). The method includes using MOCVD to form on a dielectric layer a metal layer having a first thickness, performing a first plasma process on the metal layer, using the MOCVD process to form a metal layer having a second thickness on the metal layer having the first thickness and performing a second plasma process on the metal layer having the second thickness, wherein the second plasma process has an energy level greater than the energy level of the first plasma process.

### CROSS-REFERENCE TO RELATED APPLICATION

This patent application claims priority to Korean Patent Application No. 10-2006-0009787, filed Feb. 1, 2006, the disclosure of which is hereby incorporated by reference in its entirety.

### FIELD OF THE INVENTION

The present invention relates to methods of forming metal layers.

### BACKGROUND

A metal-organic chemical vapor deposition (MOCVD) process presenting an advantage of being a low-temperature process can be used to form a top electrode of a metal-insulator-metal (MIM) capacitor. The top electrode of the MIM capacitor can generally include a TiN layer. In the MOCVD process, a TiN layer can be deposited using an organic precursor such as a tetrakis-dimethylamino titanium (TDMAT), followed by removal of an organic compound including carbon and hydrogen and impurities using a plasma process.

During a chemical vapor deposition (CVD) process using TiCl₄ as an inorganic precursor, a thin layer having a relatively low chloride content can be formed at a temperature of about 500° C. or higher. In a method of depositing a TiN layer using a MOCVD process, a thin layer can be deposited using pyrolysis. Since a thin layer deposited by pyrolysis may be a porous thin layer having a relatively high oxygen content, an organic compound including carbon and oxygen and impurities in the thin layer can be removed using an N₂ and/or H₂ plasma process after deposition to improve the density of the thin layer.

However, when improving the density of the thin layer through a plasma process, the quality of the dielectric layer may deteriorate due, at least in part, to the plasma impact. Therefore, the leakage current of the MIM capacitor may increase. In an effort to prevent the dielectric layer from being damaged through a plasma process, in case of decreasing the plasma power, an increase in the organic content and impurities in a TiN layer of a top electrode may occur such that resistivity increases. Additionally, reliability of the thin layer may decrease due, at least in part, to a thermal budget when the thin layer has a relatively large amount of impurities present.

### SUMMARY OF THE INVENTION

Embodiments of the present invention provide methods of forming a metal layer. Particular embodiments provide sufficient removal of components including carbon and impurities in the metal layer and/or provide a dielectric layer that is minimally damaged, if at all, through a plasma process when forming the metal layer on a dielectric layer by using a MOCVD process.

Embodiments of the present invention further provide using a metal-organic chemical vapor deposition (MOCVD) process to form a metal layer having a first thickness on a dielectric layer, performing a first plasma process on the metal layer, using the MOCVD process to form a metal layer having a second thickness on the metal layer having the first thickness and performing a second plasma process on the metal layer having the second thickness, wherein the second plasma process has an energy level greater than the energy level of the first plasma process.

Embodiments of the present invention also provide a method including forming a dielectric layer and forming a metal layer having a first thickness on the dielectric layer by using a MOCVD process. A first plasma process on the metal layer is performed. A second plasma process is performed on the metal layer having the second thickness with an energy level higher than that of the first plasma process. The plasma energy can be determined based upon the plasma power and/or a plasma processing period.

In some embodiments, a metal layer having a second thickness is formed on the first plasma-processed metal layer by using a MOCVD process. The second plasma process is performed using a higher energy level than the first plasma. That is, the second plasma process is performed using a greater plasma power and/or for a longer period of time than the first plasma process.

In further embodiments, a plurality of metal layers having the second thickness may be formed on the metal layer having the first thickness. Forming the metal layer having the second thickness and performing the second plasma process are alternately performed, and in some embodiments, at least several times, to form a plurality of metal layers having the second thickness on the metal layer having the first thickness. The metal layer having the first thickness can be formed by alternately segmenting a thickness to form the metal layer with a predetermined thickness and performing the first plasma process several times.

In other embodiments, the first thickness and the second thickness may be at least substantially similar or the same, i.e. identical or equal. In other embodiments, the first thickness may be thicker than the second thickness. In some embodiments, the first plasma process and the second plasma process may be performed using the same energy level that is sufficient to at least partially remove impurities and organic compounds in the respective metal layers having the first thickness and second thickness.

In some embodiments, the present invention provides a method of forming a metal layer including using a metal-organic chemical vapor deposition (MOCVD) process to form a metal layer having a first thickness on a dielectric layer, performing a first plasma process on the metal layer, wherein the plasma power of the first plasma process is in a range from about 1250 to 1750 W, using the MOCVD process to form a metal layer having a second thickness on the metal layer having the first thickness and performing a second plasma process on the metal layer having the second thickness, wherein the plasma power of the second plasma process is in a range from about 1250 to 1750 W.

### BRIEF DESCRIPTION OF THE FIGURES

The above aspects of the present invention will become more apparent by describing in detail embodiments of the present invention with reference to the attached drawings in which:

FIG. 1 presents a cross-sectional view of a conventional capacitor;

FIGS. 2 through 4 present cross-sectional views illustrating a method of forming a metal layer according to some embodiments of the present invention;

FIGS. 5 through 8 present respective flowcharts illustrating a method for forming a metal layer according to some embodiments of the present invention; and

FIGS. 9 and 10 present graphs illustrating each atomic emission spectrometry (AES) in a plasma-processed TiN layer at 750 W and a plasma-processed TiN layer at 1750 W, respectively.

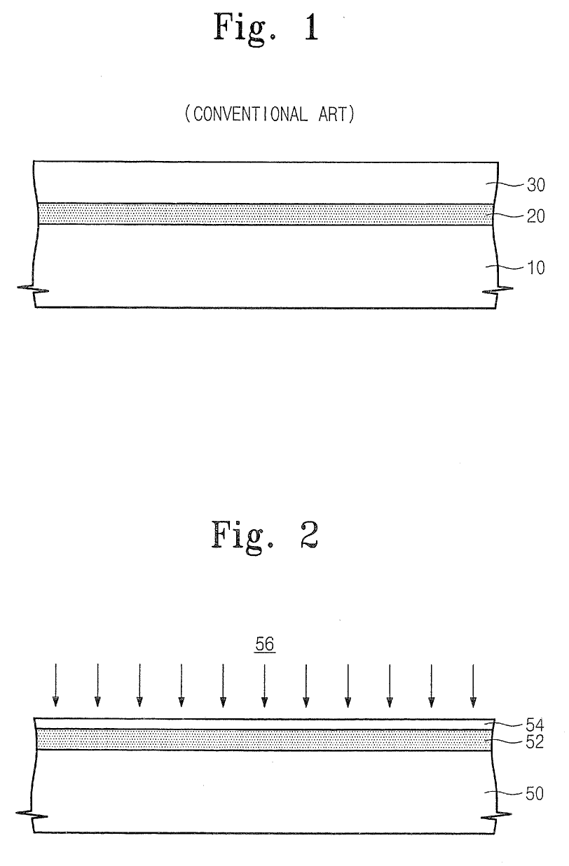

### DETAILED DESCRIPTION

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

Unless otherwise defined, all terms, including technical and scientific terms used in this description, have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Moreover, it will be understood that steps comprising the methods provided herein can be performed independently or at least two steps can be combined. Additionally, steps comprising the methods provided herein, when performed independently or combined, can be performed at the same temperature and/or atmospheric pressure or at different temperatures and/or atmospheric pressures without departing from the teachings of the present invention.

In the drawings, the thickness of layers and regions are exaggerated for clarity. It will also be understood that when a layer is referred to as being “on” another layer or substrate or a reactant is referred to as being introduced, exposed or feed “onto” another layer or substrate, it can be directly on the other layer or substrate, or intervening layers can also be present. However, when a layer, region or reactant is described as being “directly on” or introduced, exposed or feed “directly onto” another layer or region, no intervening layers or regions are present. Additionally, like numbers refer to like compositions or elements throughout.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments of the present invention are further described herein with reference to cross-section illustrations that are schematic illustrations of idealized embodiments of the present invention. As such, variations from the shapes of the illustrations as a result, for example, of manufacturing techniques and/or tolerances, are to be expected. In particular, the regions illustrated in the figures are schematic in nature and their shapes are not intended to illustrate the precise shape of a region of a device and are not intended to limit the scope of the present invention.

As will be appreciated by one of ordinary skill in the art, the present invention may be embodied as compositions and devices including the compositions as well as methods of making and using such compositions and devices.

Embodiments of the present invention are further described herein in conjunction with the accompanying drawings.

FIGS. 2 through 4 present cross-sectional views illustrating a method of forming a metal layer according to some embodiments of the present invention.

Referring to FIG. 2, a top electrode of a metal-insulator-metal (MIM) capacitor is formed using a MOCVD process. Since the MIM capacitor may have a dielectric layer interposed between metal electrodes and may not have frequency characteristics unlike a semiconductor electrode, MIM capacitors have been widely used in semiconductor logic that may require high speed operation. To form the MIM capacitor, a bottom electrode 50 is formed on a predetermined region of the semiconductor substrate, and a dielectric layer 52 is formed on the bottom electrode 50. The bottom electrode 50 can include a metal layer, and a metal insulator semiconductor (MIS) capacitor can include a semiconductor layer.

A metal layer 54 having a first thickness is formed on the dielectric layer 52 using a MOCVD process, and a first plasma process 56 having an energy level that results in minimal damage, if any, to the dielectric layer 52 is performed to at least partially remove an organic compound and at least some impurities. At this point, the first plasma process 56 may be performed at a lower energy level to reduce and/or prevent damage to the dielectric layer 52. Alternatively, the first thickness of the metal layer 54 may be adjusted to reduce and/or prevent damage to the dielectric layer 52 during the first plasma process 56. When the first plasma process 56 is performed at a lower energy to reduce and/or prevent damage to the dielectric layer 52, the thickness of the metal layer 54 is segmented and deposited to at least partially remove an organic compound and at least some impurities in the metal layer 54, and then a first plasma process is performed after each of the segmented thin layers is deposited.

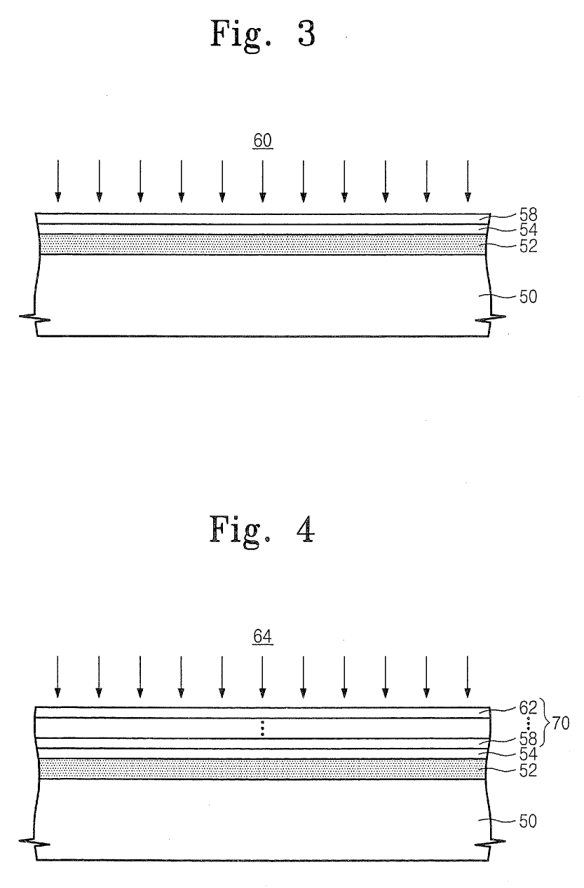

Referring to FIG. 3, a metal layer 58 having a second thickness is formed on the metal layer 54 having the first thickness by using a MOCVD process, and an organic compound and at least some impurities are at least partially removed in the metal layer 58 having the second thickness. Since the metal layer 54 having the first thickness is formed on the dielectric layer 52, the second plasma process 60 can be performed at a higher energy level than the first plasma process 56. The first and second thicknesses of the metal layers 54 and 58 can be at least similar to or the same as, or the second thickness can be greater than the first thickness because, at least in part, the second plasma process 60 has a higher energy level than the first plasma process 56.

Referring to FIG. 4, a desirable thickness of the top electrode 70 can be obtained by alternately depositing a metal layer 62 and performing a plasma process at least several times. According to embodiments of the present invention, when the top electrode 70 is formed using a MOCVD process, a desirable thickness of the top electrode 70 can be obtained by repeated metal layer depositions and plasma processes. Moreover, the metal layer in a portion contacting a dielectric layer 52 can reduce and/or prevent the dielectric layer 52 from being damaged by at least reducing a plasma energy level or increasing a metal layer thickness. Additionally, a metal layer deposited on a metal layer portion contacting a dielectric layer 52 can exhibit increased resistivity and reliability by performing a plasma process with an energy level that can sufficiently remove at least some impurities and an organic compound in the metal layers. The energy in the plasma process can be adjusted by adjusting the plasma energy and the plasma processing period.

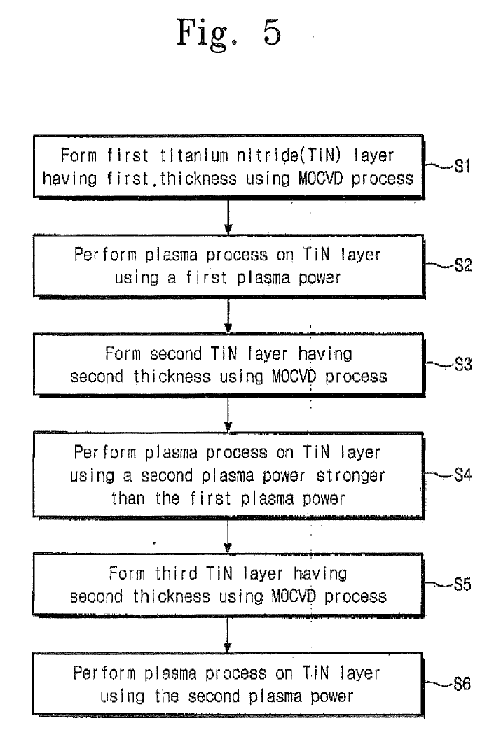

FIG. 5 presents a flowchart illustrating a method of forming a metal layer by using a MOCVD process according to some embodiments of the present invention.

Referring to FIG. 5, a bottom electrode and a dielectric layer are formed, and a first TiN layer having a first thickness is formed on the dielectric layer by using a MOCVD in process S1. The first TiN layer has a thickness of about 100 Å or below to at least partially remove impurities and an organic compound during a plasma process having a lower energy level. A plasma process is performed on the first TiN layer by using a first plasma power in process S2. The first plasma power is a power that results in minimal damage, if any, to a dielectric layer below the first TiN layer. In the TiN layer having a thickness of about 100 Å, minimal damage, if any, occurs to the dielectric layer by a plasma power between about 500 and 750 W. The plasma power can be appropriately adjusted according to the thickness of a deposited metal layer. When the thickness is relatively thin, the damage to the dielectric layer can be reduced and/or prevented using a lower power, and when the thickness is relatively thick, an organic compound and impurities in a metal layer can at least be partially removed using a stronger power.

In process S3, a second TiN layer having a second thickness is formed on the plasma-processed first TiN layer by using a MOCVD process. The second TiN layer can be deposited to provide a thickness that is greater than, at least similar to or the same as the first TiN layer.

In process S4, a plasma process is performed on the second TiN layer with a stronger second plasma power than the first plasma power. Since the first TiN layer is formed on the dielectric layer, a dielectric layer below the second TiN layer that is disposed on the first TiN layer may be minimally damaged, if at all, when applying a stronger second plasma power than the first plasma power. For example, when the second TiN layer is formed to a thickness of about 100 Å, a plasma power between about 1250 and 1750 W is applied to the second TiN layer.

In process S5, a third TiN layer is deposited on the plasma-processed second TiN layer. The third TiN layer can be deposited under conditions at least similar to, if not identical to those of the second TiN layer. In process S6, the third TiN layer is formed with the second plasma power. A desirable thickness of the top electrode can be formed by performing a TiN layer deposition and a plasma process under conditions at least similar to, if not identical to, those of the second TiN layer.

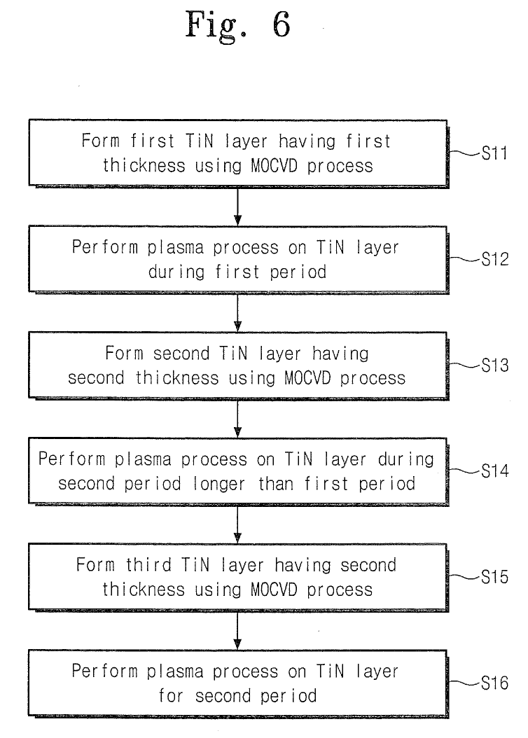

FIG. 6 presents a flowchart illustrating a method of forming a metal layer by using a MOCVD process according to some embodiments of the present invention.

Referring to FIG. 6, a bottom electrode and a dielectric layer are formed, and a first TiN layer having a first thickness is formed on the dielectric layer by using a MOCVD process in process S11. The first TiN layer has a thickness of about 100 Å or below to at least partially remove impurities and an organic compound during a plasma process having a lower energy. In process S12, a plasma process is performed on the first TiN layer during a first period. The plasma processing period results in minimal, if any, damage to the dielectric layer below the first TiN layer. In the TiN layer of about 100 Å, a plasma process with about 1750 W is performed during a time period in a range from about 15 to 35 sec in order to reduce and/or prevent damage to the dielectric layer. The process period can be appropriately adjusted according to the thickness of the deposited metal layer and the plasma power. When the thickness is relatively thin, the damage to the dielectric layer can be reduced and/or prevented using a lower power, and when the thickness is relatively thick, an organic compound and impurities in a metal layer can be at least partially removed by performing a plasma process for a specified period of time, such as seconds, minutes or hours.

In process S13, a second TiN layer having a second thickness is formed on the plasma-processed first TiN layer by using a MOCVD process. The second TiN layer can be deposited to provide a thickness that is greater than, at least similar to or the same as the first TiN layer.

In process S14, a plasma process is performed on the second TiN layer during a second period that is longer than the first period. Since the first TiN layer is formed on the dielectric layer, the dielectric layer is minimally damaged, if at all, when a plasma process is performed on the second TiN layer deposited on the first TiN layer for hours. For example, when the second TiN layer is formed to a thickness of about 100 Å, a plasma process with about 1750 W is performed on the second TiN layer during a period of time in a range from about 35 to 55 sec.

In process S15, a third TiN layer is deposited on the plasma-processed second TiN layer. The third TiN layer can be deposited under conditions at least similar to, if not identical to, those of the second TiN layer. In process S16, a plasma process is performed on the third TiN layer for the second period. A desirable thickness of the top electrode can be formed by alternately performing a TiN layer deposition and a plasma process under conditions at least similar to, if not identical to, those of the second TiN layer.

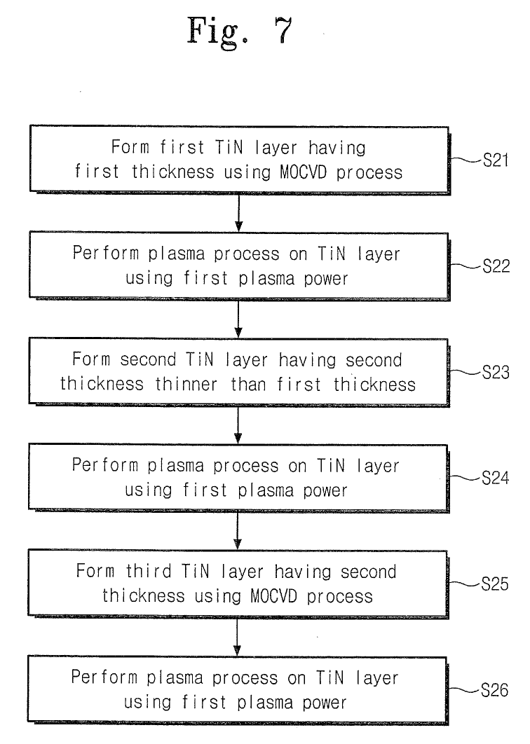

FIG. 7 presents a flowchart illustrating a method of forming a metal layer using a MOCVD process according to some embodiments of the present invention.

Referring to FIG. 7, a bottom electrode and a dielectric layer are formed, and a first TiN layer having a first thickness is formed on the dielectric layer process using MOCVD in process S21. The first TiN layer has a thickness of about 100 Å or higher in order to reduce or prevent damage to the dielectric layer by using a plasma process having a higher energy level. In process S22, a plasma process with a first plasma power is performed on the first TiN layer. The first plasma power results in minimal, if any, damage to the dielectric layer below the first TiN layer. When a TiN layer is formed having a thickness of about 150 Å, the damage to the dielectric layer is reduced or prevented by a plasma power between about 1250 and 1750 W. The plasma power can be appropriately adjusted according to the thickness of the deposited metal layer. When the thickness is relatively thin, the damage to the dielectric layer can be reduced or prevented using a lower power, and when the thickness is relatively thick, an organic compound and impurities in a metal layer can be at least partially removed using a stronger power.

In process S23, a second TiN layer having a second thickness is formed on the plasma-processed first TiN layer by using a MOCVD process. The second TiN layer can be a thinner layer in comparison to the first TiN layer.

In process S24, a plasma process is performed on the second TiN layer with a plasma power at least similar to or identical to the first plasma power. Since the first TiN layer is formed on the dielectric layer, the damage to the dielectric layer is reduced or prevented in a stronger plasma power even if the second TiN layer is tenuously deposited on the first TiN layer. The plasma process of the second TiN layer is not limited to the first plasma power, and thus, can be performed at a higher power or a lower power than the first plasma power.

In process S25, a third TiN layer is deposited on the plasma-processed second TiN layer. The third TiN layer can be deposited under conditions at least similar to, if not identical to, those of the second TiN layer. In process S26, a plasma process having the first plasma power is performed on the third TiN layer. The TiN layer deposition and the plasma process are performed under conditions at least similar to, if not identical to, those of the second TiN layer to form a top electrode having a desirable thickness.

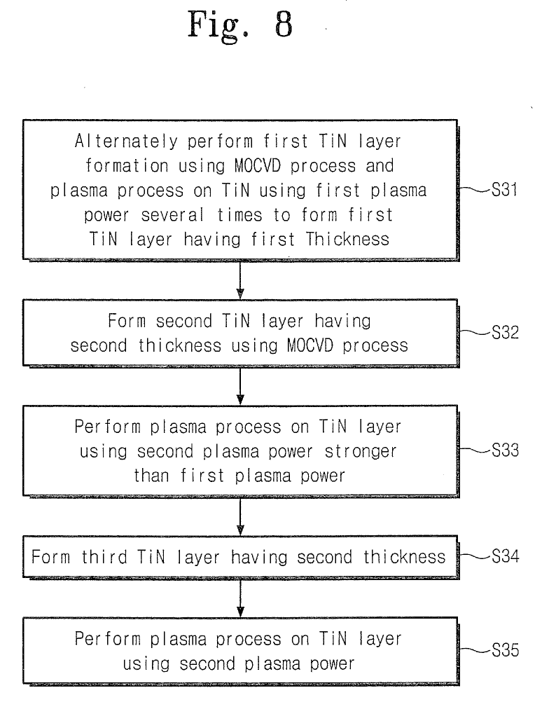

FIG. 8 presents a flowchart illustrating a method of forming a metal layer by using a MOCVD process according to some embodiments of the present invention.

Referring to FIG. 8, a bottom electrode and a dielectric layer are formed, and a first TiN layer having a first thickness is formed on the dielectric layer by using a MOCVD process by repeatedly forming the first thickness by using a MOCVD process and performing a TiN layer plasma process with a first plasma power in process S31. When a metal layer is formed on the dielectric layer with a predetermined thickness during a plasma process, there can be a minimum energy level that may damage the dielectric layer. Accordingly, when processing a metal layer with the minimum energy level, a metal layer is tenuously formed to at least partially remove an organic compound and impurities. In particular embodiments, each first thickness can be more segmented to perform a metal layer deposition and a plasma process several times. In other embodiments, a plasma process is uniformly performed on the top and the bottom of the metal layer having a first thickness.

A second TiN layer having a second thickness is formed on the plasma-processed first TiN layer by using a MOCVD process in operation S32. The second TiN layer can be deposited to provide a thickness that is greater than, at least similar to or the same as the first TiN layer.

The plasma process is performed on the second TiN layer with a stronger second plasma power than the first plasma power in process S33. Since the first TiN layer is formed on the dielectric layer, the damage of the dielectric layer can be reduced or prevented even if a plasma process having a plasma power stronger than the first plasma power is performed on the second TiN layer that is deposited on the first TiN layer. For example, when the second TiN layer is formed having a thickness of about 100 Å, a plasma process is performed on the second TiN layer with a plasma power between about 1250 and 1750 W.

A third TiN layer is deposited on the plasma-processed second TiN layer in process S34. The third TiN layer can be formed under conditions at least similar to, if not identical to, those of the second TiN layer. In process S35, a plasma process is performed on the third TiN layer by using a second plasma power. A desirable thickness of the top electrode can be formed using a TiN layer deposition and a plasma process under conditions at least similar to, if not identical to, those of the second TiN layer.

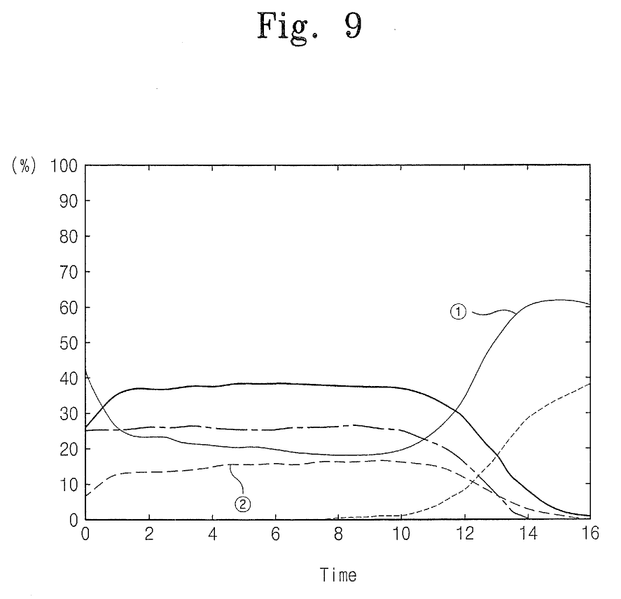

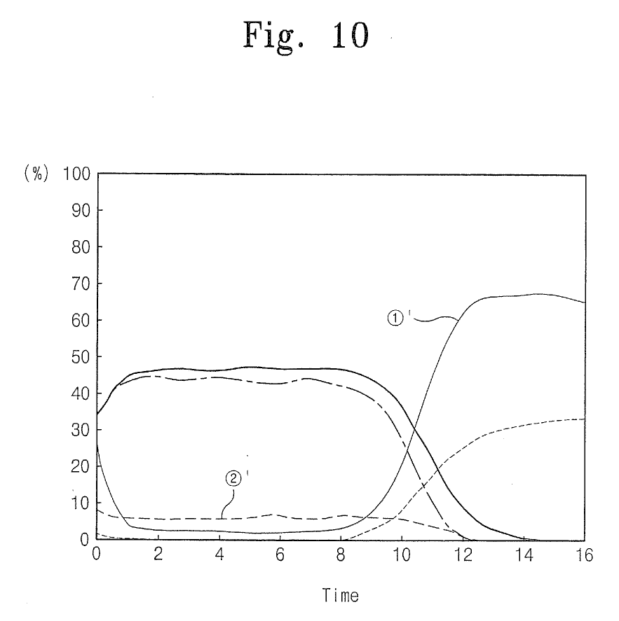

FIGS. 9 and 10 present graphs illustrating atomic emission spectrometry (AES) in a plasma-processed TiN layer at 750 W and a plasma-processed TiN layer at 1750 W, respectively. The test material constitutes a TiN layer of about 100 Å and is plasma-processed at about 1.3 Torr during about 35 sec. The x-axis represents a sputter period when measuring an AES, and the y-axis represents atom content percentage.

Referring to FIGS. 9 and 10, after analyzing the AES, when a TiN layer is N₂/H₂ plasma-processed at a lower power of 750 W, 15% carbon is included and 20% oxygen is included \textcircled{1} such that a porous layer is deposited. When a TiN layer is N₂/H₂ plasma-processed at a higher power of 1750 W, a 7 to 8% carbon is included \textcircled{2}′ such that a TiN layer is formed more densely than the TiN layer that is plasma-processed at 750 W.

According to embodiments of the present invention, a plasma process is performed at a lower energy in order to reduce or prevent damage to the metal layer that is disposed on a portion contacting a dielectric layer. Additionally, a plasma process having a relatively high energy is performed on a metal layer formed above the metal layer that is directly above the dielectric layer. Therefore, the damage to the dielectric layer can be reduced or prevented and also the density of the metal layer may increase. Energy in a plasma process can be determined by a plasma power and/or the processing period. Accordingly, the energy in a plasma process may become stronger by increasing the plasma power and the plasma processing period.

Moreover, according to embodiments of the present invention, a metal layer on a portion contacting a dielectric layer is formed of a greater than predetermined thickness such that a plasma process can be performed. A metal layer above the metal layer on the portion contacting the dielectric layer can be formed of a reduced thickness by performing a deposition and plasma process several times.

According to some embodiments of the present invention, the leakage current gain can be reduced or prevented by minimizing the damage to the dielectric layer. Resistivity can be increased by improving the density of the metal layer. Since a thermal budget for removing an impurity can, at a minimum, be reduced through a plasma process, the reliability of a capacitor can be improved.

The above-disclosed subject matter is to be considered illustrative, and not restrictive, and the appended claims are intended to cover all such modifications, enhancements, and other embodiments, which fall within the true spirit and scope of the present invention.

What is claimed is:

1. A method of forming a metal layer, comprising:
using a metal-organic chemical vapor deposition (MOCVD) process to form on a dielectric layer a metal layer having a first thickness;
performing a first plasma process on the metal layer;
using the MOCVD process to form a metal layer having a second thickness on the metal layer having the first thickness; and
performing a second plasma process on the metal layer having the second thickness, wherein the second plasma process has an energy level greater than the energy level of the first plasma process.

2. The method of claim 1, wherein forming the metal layer having the second thickness and performing the second plasma process are alternately performed to provide a plurality of metal layers having the second thickness on the metal layer having the first thickness.

3. The method of claim 1, wherein the second plasma process is performed using a greater plasma power than the plasma power of the first plasma process.

4. The method of claim 3, wherein the first and second plasma processes are performed for the same length of time.

5. The method of claim 1, wherein the second plasma process is performed for a period of time that is longer than the period of time for the first plasma process.

6. The method of claim 5, wherein the second plasma process is performed using a greater plasma power than the first plasma process.

7. The method of claim 5, wherein the first and second plasma processes are performed using at least a substantially similar plasma power.

8. The method of claim 1, wherein forming a metal layer having a first thickness and performing the first plasma process are alternately performed to provide the metal layer having the first thickness.

9. The method of claim 1, wherein the first thickness is equal to the second thickness.

10. The method of claim 1, wherein the first thickness is greater that the second thickness.

11. A method of forming a metal layer, comprising:
using a MOCVD process to form on a dielectric layer a metal layer having a first thickness;
performing a first plasma process on the metal layer;
using the MOCVD process to form a metal layer having a second thickness on the metal layer having the first thickness, wherein the second thickness is greater than the first thickness; and
performing a second plasma process on the metal layer having the second thickness.

12. The method of claim 11, wherein forming the metal layer having the second thickness and performing the second plasma process are alternately performed to provide a plurality of metal layers having the second thickness on the metal layer having the first thickness.

13. The method of claim 11, wherein the second plasma process is performed using a greater plasma power than the first plasma process.

14. The method of claim 13, wherein the first and second plasma processes are performed for the same length of time.

15. The method of claim 11, wherein the second plasma process is performed for a period of time that is longer than the period of time for the first plasma process.

16. The method of claim 15, wherein the second plasma process is performed using a greater plasma power than the first plasma process.

17. The method of claim 15, wherein the first and second plasma processes are performed using at least a substantially similar plasma power.

18. The method of claim 11, wherein forming a metal layer having a first thickness and performing the first plasma process are alternately performed to provide the metal layer having the first thickness.

19. A method of forming a metal layer, comprising:
using a metal-organic chemical vapor deposition (MOCVD) process to form on a dielectric layer a metal layer having a first thickness on a dielectric layer;
performing a first plasma process on the metal layer, wherein the plasma power of the first plasma process is in a range from about 1250 to 1750 W;
using the MOCVD process to form a metal layer having a second thickness on the metal layer having the first thickness; and
performing a second plasma process on the metal layer having the second thickness, wherein the plasma power of the second plasma process is in a range from about 1250 to 1750 W.

20. The method of claim 1, wherein the metal layer comprises TiN.
